(19) United States
(12) Patent Application Publication
(10) Pub. No.: US 2019/0134717 A1
(43) Pub. Date: May 9, 2019

(54) SHRINK-FIT CHUCK

(71) Applicant: KARL SCHUESSLER GMBH & CO. KG, Bodelshausen (DE)

(72) Inventor: Klaus SCHUESSLER, Hechingen-Sickingen (DE)

(73) Assignee: KARL SCHUESSLER GMBH & CO. KG, Bodelshausen (DE)

(21) Appl. No.: 16/096,899

(22) PCT Filed: Apr. 26, 2017
(86) PCT No.: PCT/EP2017/059928

§ 371 Date: Oct. 26, 2018

(30) Foreign Application Priority Data
Apr. 27, 2016 (DE) 10 2016 005 081.0

(51) Int. Cl. B23B 31/107; B23B 31/117; B23B 31/02; B23B 31/00

(52) U.S. Cl. CPC B23B 31/1075; B23B 31/1179; B23C 5/26; B23B 31/005; B23B 31/023

(57) ABSTRACT

The invention concerns a shrink-fit chuck (1) for clamping an object, in particular for clamping a milling cutter in a milling machine, having a cylindrical receiving bore (3) for receiving a cylindrical shank of the object to be clamped, the receiving bore (3) extending in the shrink-fit chuck (1) and being bounded on the outside by a wall (4). The shrink-fit chuck (1) according to the invention is characterised by a rib (12) which extends transversely to the longitudinal axis (13) of the receiving bore (3) and projects inwards from the wall (4) of the receiving bore (3) into the receiving bore (3), so that the rib (12) permits the complete insertion of the shank (5) into the receiving bore (3) only in a predetermined angular position of the shank (5).

The invention concerns a shrink-fit chuck for clamping an object, in particular for clamping a tool in a machine tool, preferably for clamping a milling cutter in a milling machine.

Such a shrink-fit chuck is known for example from DE 20 2014 008 275 U1 and has a standard cone interface on the side of the machine tool to mount the shrink-fit chuck in the machine tool (e.g. milling machine).

On the tool side, on the other hand, the shrink-fit chuck has a cylindrical receiving bore in the main bore, into which a tool shank of the tool to be clamped (e.g. milling cutter) can be inserted in order to be clamped when the previously heated shrink-fit chuck cools down.

In addition, the well-known shrink-fit chuck has a clamping screw that can be screwed into a threaded bore transverse to the receiving bore and acts with its free end on a clamping surface in the outer surface of the tool shank.

On the one hand, the clamping screw prevents the tool from being pulled out axially when screwed in, as the clamping surface in the outer surface of the tool shank is slightly inclined so that the tool shank expands towards its free end.

On the other hand, the clamping screw also prevents the tool from turning in the clamped state when screwed in, since the clamping screw is slightly eccentric with respect to the diameter of the receiving bore. However, it is important for this function that the tool shank is inserted into the shrink-fit chuck in a suitable angular position relative to the clamping screw. In the case of the well-known shrink-fit chuck described above, this can be achieved by means of a spring-loaded positioning screw, but this is not optimal.

With regard to the technical background of the invention, reference should also be made to DE 94 11 260 U1, DE 10 2014 208 140 A1, DE 10 2014 016 321 B3, DE 20 2011 103 203 U1 and DE 10 2011 081 523 A1.

The invention is therefore based on the task of improving the angular positioning of the tool shank when it is inserted into the shrink-fit chuck.

This task is solved by using a shrink-fit chuck according to the invention in accordance with the main claim.

First of all, it should be mentioned that the shrink-fit chuck is generally suitable for clamping an object, such as a workpiece and preferably a tool. In a preferred embodiment, the tool is a milling cutter that can be clamped in a milling machine using the invention's shrink-fit chuck. However, the invention is not limited to milling machines with regard to the type of tool and machine tool, but can also be realized with other types of machine tools. It should also be mentioned that the object to be clamped does not necessarily have to be a tool. Rather, for example, a workpiece or other object can also be clamped by means of the shrink-fit chuck in accordance with the invention.

In accordance with the state of the art, the shrink-fit chuck according to the invention initially has an essentially cylindrical receiving bore in order to accommodate an essentially cylindrical shank of the object to be clamped. The receiving bore for the object to be clamped (e.g. milling cutter) runs through the shrink-fit chuck and is bounded on the outside by a wall.

The invention is now characterized by a rib that runs transversely to the longitudinal axis of the receiving bore in the shrink-fit chuck and projects inwards from the wall of the receiving bore into the receiving bore, so that the rib allows the complete insertion of the shaft into the receiving bore only in a specific angular position of the shaft. During a clamping operation, the shrink-fit chuck is first heated so that the receiving bore widens. The object to be clamped is then inserted axially into the receiving bore of the shrink-fit chuck, whereby the angular position of the object is irrelevant at first. When the object is inserted into the receiving bore, the free end of the object finally hits the rib, which initially prevents further axial insertion of the object. The object is then rotated by the operator in such a way that the rib in the receiving bore on the one hand and the clamping surface in the outer surface of the object to be clamped on the other hand are aligned parallel, whereupon the rib then no longer blocks further insertion of the object to be clamped. The object to be clamped is then completely inserted into the receiving bore until it strikes a stop (e.g. bottom, shoulder, length adjustment screw) in the receiving bore.

The shrink-fit chuck according to the invention preferably also has a threaded bore which completely penetrates the wall of the receiving bore and runs transversely to the longitudinal axis of the receiving bore, as known from DE 20 2014 008 275 U1. A clamping screw can be screwed into this threaded bore which, when screwed in, acts with its free end on the clamping surface in the circumferential surface of the shank of the object to be clamped and thus prevents axial withdrawal of the object, since the clamping surface in the circumferential surface of the shank is slightly inclined to the longitudinal axis of the shank, so that the shank widens towards its free end. When unscrewed, the clamping screw does not act on the clamping surface and thus allows the item to be pulled axially out of the shrink-fit chuck.

In the preferred embodiment of the invention, however, the clamping screw has a further function. The clamping screw not only prevents the object to be clamped from being pulled axially out of the shrink-fit chuck, but also prevents the object to be clamped from rotating about its longitudinal axis. The threaded bore for the clamping screw is therefore preferably eccentrically arranged in relation to the diameter of the receiving bore and is therefore preferably not exactly radial in relation to the longitudinal axis of the receiving bore. This offers the advantage that the clamping screw does not act centrally on the clamping surface but eccentrically, so that the clamping screw can oppose the object to be clamped with a torque in order to prevent the object to be clamped from rotating in the shrink-fit chuck. The threaded bore for the clamping screw preferably runs in a plane perpendicular to the longitudinal axis of the receiving bore. It should be mentioned here that the threaded bore with the longitudinal axis preferably does not cut the longitudinal axis of the receiving bore. The longitudinal axis of the threaded bore on the one hand and the longitudinal axis of the receptacle hole on the other are therefore preferably skew in a mathematical sense, i.e. they do not lie in one plane and are not parallel. The vertical distance between the longitudinal axis of the threaded bore for the clamping screw on the one hand and the diameter of the receiving bore on the other is preferably in the range from 1 mm to 5 mm or 2 mm to 4 mm.

It should also be mentioned that the rib preferably has a straight inner edge which is transverse to the longitudinal axis of the receiving bore. The inclined clamping surface in the circumferential surface of the object to be clamped is preferably essentially flat. With a correct angular alignment of the object to be clamped with respect to the shrink-fit chuck, the straight edge of the rib thus runs substantially parallel to the flat clamping surface, which allows the object to be clamped to be inserted completely into the receiving bore of the shrink-fit chuck until the object to be clamped strikes with its free end against a stop (e.g. bottom, shoulder, length adjustment screw) in the receiving bore.

It should also be mentioned that, viewed from the opening of the receiving bore, the rib is preferably located behind the threaded bore for the clamping screw. The rib is therefore preferably located in the axial direction between the bottom of the receiving bore on the one hand and the threaded bore on the other hand. However, the rib can also be arranged in a different axial position.

It has already been mentioned above that the clamping surface on the object to be clamped preferably prevents axial withdrawal of the object from the shrink-fit chuck when the clamping screw is screwed into the corresponding threaded bore. For this purpose, the clamping surface in the circumferential surface of the shank of the object to be clamped is inclined by a certain angle of inclination relative to the longitudinal axis of the shank, whereby this angle of inclination can be in the range of 1°-10°, 1°-6°, 1°-4° or 1°-3°, for example. In the preferred embodiment of the invention, this angle of inclination is equal to 2°.

It should also be mentioned that the inclined clamping surface on the shaft extends over a certain axial length. Basically, such an inclined clamping surface is also known as a whistle notch clamping surface and is standardized in the technical standard DIN 1835. In the case of the invented shrink-fit chuck, however, this clamping surface is preferably shortened in axial direction and preferably shifted in the direction of the shaft end. For example, the inclined clamping surface can have an axial length in the range from 5 mm to 40 mm, 5 mm to 35 mm, 5 mm to 30 mm, 10 mm to 25 mm, 15 mm to 22 mm, 17 mm to 21 mm, 18 mm to 21 mm or 19 mm to 21 mm. In the preferred embodiment of the invention, the length of the inclined clamping surface is 20 mm.

In the preferred embodiment, however, the inclined clamping surface on the shaft extends in the axial direction to the free end of the shaft or at least to a chamfer on the free end of the shaft. Between the inclined clamping surface on the one hand and the free end of the shank on the other hand there is no cylindrical area of the surface of the shank in the preferred embodiment.

It should also be mentioned that the receiving bore in the shrink-fit chuck has an axial stop which represents an axial limit when the object to be clamped is pushed in. For example, this axial stop can be the bottom of the receiving bore, a shoulder in the receiving bore or a length adjustment screw. In the preferred embodiment of the invention, the threaded bore for the clamping screw is arranged at a certain axial distance from this axial stop in the receiving bore. The axial length of the clamping surface in the shell surface of the object to be clamped is then preferably greater than the axial distance between the threaded bore and the stop in the receiving bore. This is important so that the clamping screw hits the inclined clamping surface in the screwed-in state when the object to be clamped is completely pushed into the receiving bore in the shrink-fit chuck up to the stop.

It has already been mentioned above that the rib in the receiving bore together with the inclined clamping surface allows angular positioning of the object to be clamped. Thus, the object to be clamped can only be fully inserted into the receiving bore if the object to be clamped is correctly positioned in relation to the clamping screw. Preferably, the rib in conjunction with the clamping surface enables a certain angular positioning tolerance, within which the object to be clamped can be fully inserted into the shrink-fit chuck. This angular positioning tolerance is preferably in the range of 1°-10°, 2°-5° or 2°-3°.

It should also be mentioned that the free end of the clamping screw can press directly against the clamping surface of the shank.

Alternatively, however, it is also possible for the clamping screw to press indirectly against the clamping surface of the shank, whereby an intermediate element (e.g. a rotatable, flattened ball) is arranged between the free end of the clamping screw and the clamping surface, as is known for example from DE 20 2014 008 275 U1.

Finally, it should be mentioned that the invention does not only claim protection for the shrink-fit chuck described above as a single component. Rather, the invention also claims protection for a tool machine (e.g. milling machine) which is equipped with such a shrink-fit chuck in accordance with the invention.

Other advantageous further training of the invention is indicated in the dependent claims or is explained in more detail below together with the description of the preferred embodiment of the invention on the basis of the figures. They show:

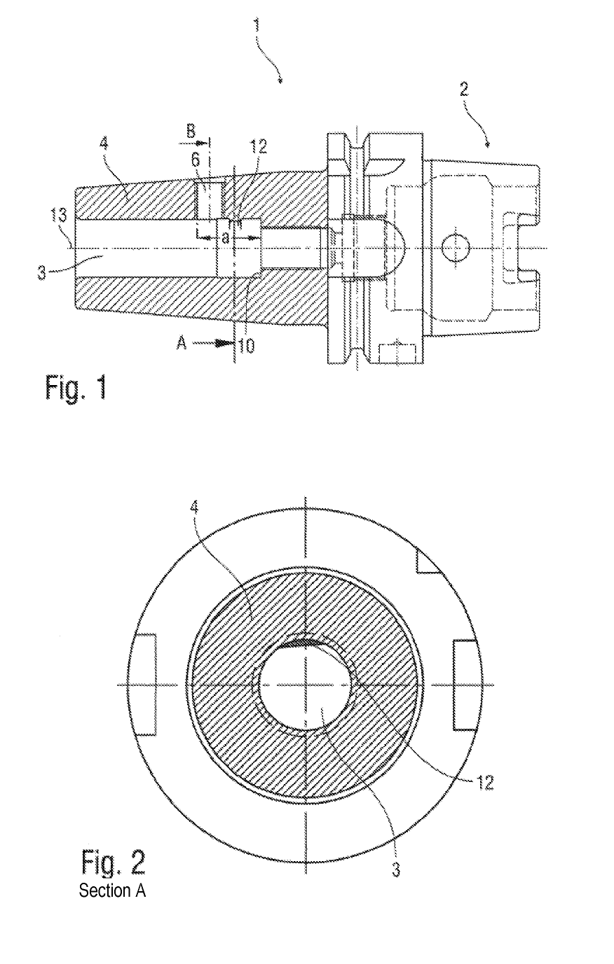

FIG. 1 shows a longitudinal view through a shrink-fit chuck according to the invention,

FIG. 2 a cross-sectional view through the shrink-fit chuck as shown in FIG. 1 along section line A,

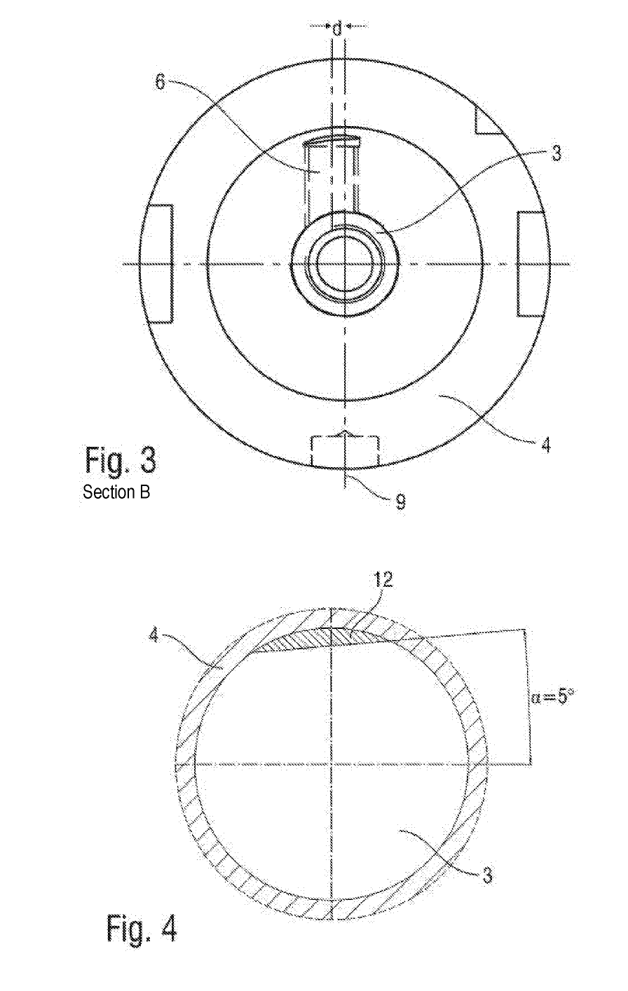

FIG. 3 a cross-sectional view through the shrink-fit chuck as shown in FIG. 1 along the section line B,

FIG. 4 a cross-sectional view through FIG. 1 in the area of the rib,

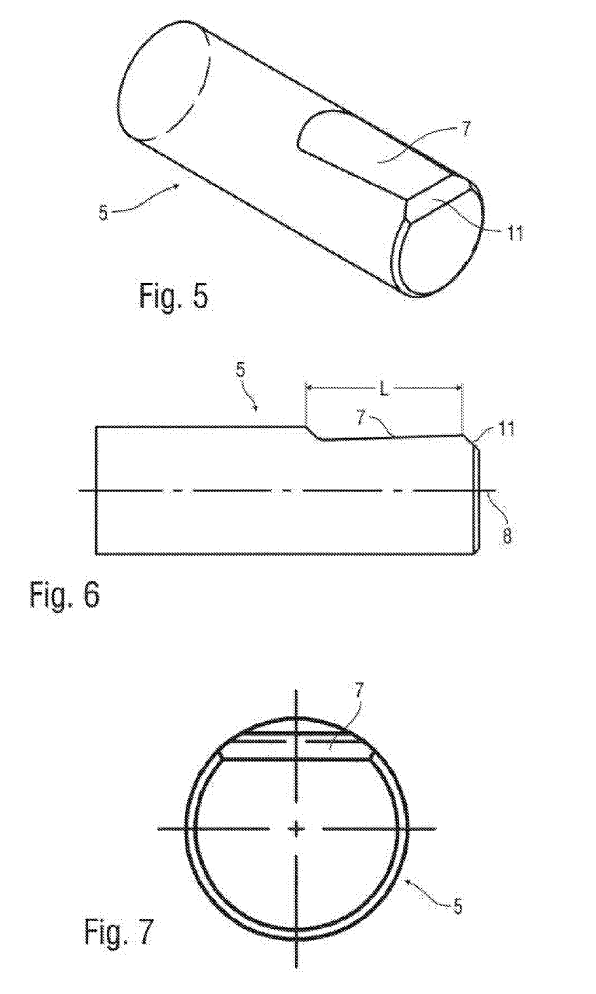

FIG. 5 a perspective view of a tool shaft for clamping in the shrink-fit chuck,

FIG. 6 a side view of the tool shaft from FIG. 5, as well as

FIG. 7 shows a front view of the tool shank from FIGS. 5 and 6 towards the free end of the tool shank.

The drawings show a shrink-fit chuck 1 according to the invention, which can be mounted in a machine tool (e.g. milling machine) by means of a standard taper interface 2, as it is known from DE 20 2014 008 275 U1.

On the tool side, the shrink-fit chuck 1 according to the invention has a cylindrical receiving bore 3, which is limited by a wall 4.

A tool shank 5 of a tool (e.g. milling cutter) can be inserted into the receiving bore 3 of the shrink-fit chuck 1, whereby the tool shank 5 is shown in FIGS. 5-7.

The wall 4 of the shrink-fit chuck 1 is completely penetrated by a threaded bore 6, whereby a clamping screw not shown can be screwed into the threaded bore 6, as known from DE 20 2014 008 275 U1.

On the one hand, the clamping screw in the threaded bore 6 prevents the tool shank 5 from being pulled out axially when screwed in. For this purpose, the clamping screw in the screwed-in state acts on an inclined clamping surface 7 in the circumferential surface of the tool shank 5. The clamping surface 7 is inclined at an angle of 2° with respect to a longitudinal axis 8, so that the tool shank 5 widens in the area of the clamping surface 7 towards its free end. The interaction of the clamping screw in the threaded bore 6 on the one hand with the clamping surface 7 on the other hand prevents the tool shank 5 from being pulled out of the shrink-fit chuck 1 in the axial direction.

On the other hand, the clamping screw in the threaded bore 6 also has a second function. In this way, the clamping screw screw screwed into the threaded bore 6 prevents the tool shank 5 in the receiving bore 3 from rotating under a mechanical load. For this purpose, the clamping screw screw screwed into the threaded bore 6 opposes the tool shank 5 with a torque which prevents the tool shank 5 from slipping through. To achieve this function, the threaded bore 6 in the wall 4 is eccentrically arranged with respect to a diameter 9 of the receiving bore 3 and at a perpendicular distance d=2 mm. This off-centre arrangement of the threaded bore 6 for the clamping screw enables the clamping screw to form an angular stop in the screwed-in position, which prevents the tool shank 5 from turning in the receiving bore 3.

It should also be mentioned that the shrink-fit chuck 1 has a shoulder 10 at the end of the receiving bore 3 which forms an axial stop for the tool shank 5. In addition, a length adjustment screw is also provided which forms an axial stop. The tool shank 5 can therefore only be inserted into the receiving bore 3 in the axial direction until the tool shank 5 touches the shoulder 10 or the length adjustment screw with its free end.

It should be mentioned here that the threaded bore 6 for the clamping screw is arranged at a certain axial distance a from the shoulder 10. The clamping surface 7 in the circumferential surface of the tool shank 5 has a corresponding axial length L. It is important here that the axial length L of the clamping surface of the tool shank 5 is greater than the distance a between the threaded bore 6 and the shoulder 10 in the receiving bore 3. This is important so that the clamping screw in the receiving bore 6 can act with its free end on the clamping surface 7 in the lateral surface of the tool shank 5.

It should also be mentioned that the tool shank 5 has a chamfer 11 at its free end. The chamfer 11 is located between the inclined clamping surface 7 and the free end of the tool shank 5. It is important that the inclined clamping surface 7 reaches up to the chamfer 11 without a cylindrical section remaining between the inclined clamping surface 7 and the free end of the tool shank 5.

In the receiving bore 3, a rib 12 is formed on the inside of the wall 4 of the receiving bore 3, which runs at right angles to the longitudinal axis 13 of the receiving bore 3 and projects inwards into the free cross-section of the receiving bore 3. The rib 12 has a straight edge, which allows the tool shank 5 to be positioned at an angle relative to the rib 12.

During a clamping operation, the shrink-fit chuck 1 is first heated in the conventional manner, which expands the receiving bore 3 and allows the tool shank 5 to be inserted.

The tool shank 5 is then inserted axially into the expanded receiving bore 3 until the tool shank 5 hits the rib 12 with its free end.

The operator then turns the tool shank 5 around its longitudinal axis 8 until the straight edge of the rib 12 is aligned parallel to the clamping surface 7 in the outer surface of the tool shank 5. In this angular position, the tool shank 5 can then be inserted further into the receiving bore 3 until the tool shank 5 finally strikes with its free end against the shoulder 10 in the receiving bore 3 or against the length adjustment screw.

The shrink-fit chuck 1 can then be cooled before the clamping screw is screwed into the threaded bore 6 until the free end of the clamping screw acts on the clamping surface 7 in the circumferential surface of the tool shank 5.

On the one hand, the screwed-in clamping screw then prevents axial extraction of the tool shank 5 from the shrink-fit chuck 1 in conjunction with the inclined clamping surface 7.

On the other hand, the screwed-in clamping screw also prevents the tool shank 5 from slipping, which could be caused by a torque load. Important for this function is a certain angular alignment of the tool shank 5 in relation to the clamping screw or the tapping hole 6. This correct angular alignment is achieved by the ingenious rib 12.

The invention is not limited to the preferred embodiment described above. Rather, a large number of variants and variations are possible which also make use of the invention idea and therefore fall within the scope of protection. In particular, the invention also claims protection for the subject-matter and the features of the dependent claims independently of the claims referred to in each case and in particular also without the features of the main claim. The invention thus comprises various aspects which enjoy protection independently of each other.

### LIST OF REFERENCE SIGNS

1 Shrink-fit chuck
2 Standard cone interface for mounting in a machine tool
3 Receiving bore for tool shank
4 Wall of the receiving bore
5 Tool shank
6 Threaded bore for clamping screw
7 Clamping surface in the surface of the tool shank
8 Longitudinal axis of the tool shank
8 Diameter of the receiving bore
9 Shoulder in the receiving bore
10 Chamfer at the end of the tool shank
11 Rib in the receiving bore
13 Longitudinal axis of the receiving bore
d Distance between longitudinal axis of threaded bore and diameter of receiving bore
L Axial length of the clamping surface
a Distance between threaded bore and stop in the receiving bore

1-10. (canceled)

11. Shrink-fit chuck for clamping an object, comprising:
a) a substantially cylindrical receiving bore for receiving a substantially cylindrical shank of the object to be clamped, the receiving bore extending in the shrink-fit chuck and being bounded externally by a wall, and
b) a rib which extends transversely to the longitudinal axis of the receiving bore and projects inwards from the wall of the receiving bore into the receiving bore, so that the rib enables the shaft to be completely inserted into the receiving bore only in a specific angular position of the shaft.

12. Shrink-fit chuck according to claim 11, further comprising:
a) a threaded bore which passes completely through the wall of the receiving bore and extends transversely to the longitudinal axis of the receiving bore, and
b) a clamping screw which can be screwed into the threaded bore,
b1) the clamping screw, in the screwed-in state, acting with its free end on a clamping surface in the circumferential surface of the shank and thereby preventing axial withdrawal of the object,
b2) whereas in the unscrewed state the clamping screw does not act on the clamping surface of the shank and thus enables axial withdrawal of the object.

13. Shrink-fit chuck according to claim 12, wherein
a) the threaded bore is arranged eccentrically with respect to the diameter of the receiving bore and thus does not extend exactly radially with respect to the longitudinal axis of the threaded bore, and
b) the threaded bore extends in a plane which lies at right angles to the longitudinal axis of the receiving bore, and
c) the threaded bore with its longitudinal axis does not intersect the longitudinal axis of the receiving bore.

14. Shrink-fit chuck according to claim 13, wherein the perpendicular distance between the longitudinal axis of the threaded bore and the diameter of the receiving bore is greater than 1 mm and less than 5 mm.

15. Shrink-fit chuck according to claim 11, wherein
a) the rib has inside a straight edge which runs transversely to the longitudinal axis of the receiving bore, and
b) the inclined clamping surface on the shank of the object to be clamped is substantially flat.

16. Shrink-fit chuck according to claim 15, wherein the rib is arranged behind the threaded bore for the clamping screw when viewed from the mouth of the receiving bore.

17. Shrink-fit chuck according to claim 12,
wherein
a) the clamping surface on the shank is inclined relative to the longitudinal axis of the shank by a specific angle of inclination so that the shank widens towards its free end, and
b) the angle of inclination of the clamping surface on the shank is smaller than 10°, and
c) the angle of inclination of the clamping surface on the shank is greater than 0.1°.

18. Shrink-fit chuck according to claim 17, wherein
a) the inclined clamping surface on the shaft extends over an axial length of at least 5 mm, and
b) the inclined clamping surface on the shaft extends over an axial length of at most 40 mm, and
c) the inclined clamping surface on the shank extends in the axial direction up to the free end of the shank or at least up to a chamfer on the free end of the shank.

19. Shrink-fit chuck according to claim 11, wherein
a) the receiving bore has an axial stop up to which the shank of the object to be clamped can be pushed into the receiving bore,
b) the threaded bore for the clamping screw is arranged at a specific axial distance from the axial shoulder in the receiving bore, and
c) the axial length of the clamping surface on the object to be clamped is greater than the axial distance between the threaded bore and the stop in the receiving bore.

20. Shrink-fit chuck according to claim 11, wherein the rib in the receiving bore together with the clamping surface on the shank of the article to be clamped has an angular positioning tolerance of at least 0.1° and at most 10° when the article is inserted into the shrink-fit chuck.

21. Machine tool with a shrink-fit chuck according to claim 11.
